(19) United States
(12) Patent Application Publication
(10) Pub. No.: US 2009/0012804 A1
(43) Pub. Date: Jan. 8, 2009

(54) Network-based consensus formation method using configurable finite-state machines

(76) Inventor: Robert Lee Read, Austin, TX (US)

Correspondence Address: Robert L. Read, 1709 Norris Dr., Austin, TX, 78704, US

(21) Appl. No.: 11/879,099

(22) Filed: Jul. 16, 2007

Related U.S. Application Data
(60) Provisional application No. 60/958,178, filed on Jul. 3, 2007.

(51) Int. Cl. G06Q 99/00

(52) U.S. Cl. 705/1

(57) ABSTRACT

A computer-networked method for persons to express desires and intentions relating to a formal proposal or offer is described. Each interaction is modeled as a transition between a finite set of states. The allowed states and transitions are defined by a finite-state automaton called a way of doing business, or waydob™, decorated with various functions. The history of the interaction is recorded as an appendable but immutable list of transitions against the finite-state machine. Transitions are regulated by computable functions attached to the finite-state machine, thus permitting privileges, privacy, and other rules of the way of doing business to be enforced. By collecting parameters at transition points, commercial as well as non-commercial human interactions can be modeled and facilitated.

### BACKGROUND OF THE INVENTION

Forming agreements is a fundamental part of human relationships. Communicating desires and intentions in order to find a mutually happy agreement is the essence of forming agreements. Sometimes it is helpful to form agreements within a well-defined framework, a way of doing business, so that less has to be communicated. Humanity has developed many such frameworks. For example, the sale, the promise, the vote, and the auction, are all well-known ways of doing business. Most frameworks have obvious and definite states. The essence of the promise is that one has either promised or not, with no in-between state. In an auction, the last bid is a certain definite amount that everybody can see and understand. There are some kinds of agreements that are ambiguous, but having established the rules that define the basic conduct of business is very useful in many cases.

The development of computer networks and the current invention allow networked communication to facilitate the formation of agreements. The object of the present invention, which is part of the product offering of Konsenti™ [http://konsenti.com] is a computer-networked implementation of a formal framework in which people can express their ideas, intentions and desires based on programmable ways of doing business, or waydobs™.

This invention is related to methods of electronic commerce, and though commerce implies the exchange of money for a good or service, the present invention is generally intended to assist in forming non-commercial agreements or consensus. Therefore, while the invention may be used in commercial applications, it is also related to inventions dealing with voting, scheduling, and electronic messaging.

The basic machinery of this invention includes browser-based computer networks and databases for recording transitions. More particularly it concerns constructing a finite automaton to express the way of doing business, which is a protocol and set of rules by which humans may interact in an attempt to form a consensus. In particular, it is taught how a finite automaton can represent a way of doing business. By decorating the finite automaton with appropriate functions, an engine for conveniently displaying the state of the potential agreement, or offer, can be constructed by one skilled in the art. By accepting from users their expressions of their intentions and desires in the form of transitions of the finite-state automaton, a computer network can aid the formation of agreements.

### DESCRIPTION OF RELATED ART

### Two-Party Oriented Prior Art

U.S. Pat. No. 5,216,603 by Flores teaches an invention that is partially overlapping in intention to the present invention. That patent is similar to the present invention in that it uses a finite-state machine to attempt to guide human communication in order to arrive at a consensus. However, the patent by Flores attempts to model general conversations between two individuals, sometimes with other observers. The present invention uses a finite-state machine, but rather than attempting to model general conversations, it allows the configuration of a way of doing business, or waydob™. An individual human interaction with the system (called a “move” in the Flores patent, and a “transition” in this specification) is typically even simpler in the present invention, since the user is not creating a word or move to represent the transition, but simply selects from options allowed by the waydobs™. For example, the Flores invention allows “comment” moves. The Konsenti™ system also allows comments, but they are not considered a transition. Because the Konsenti™ system allows interactions between a huge number of participants (for example, the Simple Vote waydob™ is typically voted upon by an entire market of participants), it is potentially more powerful than the Flores invention. The Flores invention does not teach auctions, matching grants, votes, communal dinners, or slotted projects, for example, all of which are implementable via the current invention. However, since the Flores system is designed to model general conversations, it potentially supports very powerful agreements as well. Although both systems use finite-state machines to track the state of an agreement between parties, the Konsenti™ system is somewhat more rigid (and therefore simpler) once an offer has been made from a waydob™, whereas the Flores system seems to leave more possibilities open after an offer is created.

Additionally, the Flores system is based on “incompletions”, used to model needs that remain unsatisfied. No such concept exists in the present invention, as all possibilities are modeled by the allowed transitions of the offer.

The Flores system provides notions of making a counter-proposal within the state machine. The Konsenti™ system supports the notion of counter-proposals by the creation of new, but associated, offers. The Konsenti™ system can represent counter-offers within a finite-state machine, if that is needed (however, this embodiment is only preferred in the context of very simple offers.)

U.S. Pat. No. 7,155,419 to Blackman et al. describes an “Agreement Managements System™, which is similar in intent to the present invention. However, it focuses on two-party agreements, as opposed to multi-party agreements, which is a major feature of the current invention. Further, it specifies a very specific set of states and conditions, whereas the present invention concerns the flexible programming of allowed states. Both the Blackman patent and the present invention support the concept of “counter-offer”, though it seems the Blackman patent only does so within the context of a single agreement. The general focus of the Blackman patent seems to be on commercial agreements between firms, particularly with respect to prices and other aspects of a supply-chain negotiation.

### Multi-Party Prior Art

U.S. Pat. No. 6,691,153 by Hanson et al. (CL 709/206) and U.S. Pat. No. 6,457,045 by Hanson et al. (CL 709/204) appear to be the closest in purpose to the present invention. Both Konsenti™ and the Hanson patents attempt to aid group decision-making or group consensus building, and furthermore attempt to cover a wide variety of formal mechanisms for doing so. The present invention differs from those systems in providing an actual mechanism whereby a formal means of organizing interaction (or waydob™, in the parlance of the Konsenti™ website) can be implemented based on specifying small finite-state machines decorated with atomic labels and functions. This is contrasted with the patents to Hanson which leave such mechanisms unspecified, presumably to be programmed on a case-by-case basis. The Hanson patents describe a similar hardware/software system to the preferred embodiments of the current invention. Although giving a number of specific examples, those patents do not a describe a system for implementing waydobs™.

U.S. Pat. No. 6,640,230 to Alexander et al. (CL 707/10, 707/102) describes a calendar-based system for forming consensus about appointments. The overall scheme of the preferred embodiments of the Alexander disclosure is similar to the above patents to Hanson and to the present invention; though the patent to Alexander focuses more on specific methods for conveniently collating and communicating calendar-based information.

U.S. application Ser. No. 11/040,721 by VonBergen et al. describes, in U.S. CL 705/26, a network-based system for managing a set of offers. However “offers” is used in that application in a much narrower sense of a price-based commercial offer than it is used in the present application.

U.S. Pat. No. 7,085,740 by Myers (CL 705/37) is an example of teaching a specific technique for improving an auction. As such it is an extremely specific example of a single kind of waydob™ that could be implemented via the method of the present invention, given appropriate functions attached to appropriate transitions of a finite-state machine.

### Art Relating to Specific Ways of Doing Business

Since this system concerns the implementation of generic waydobs™ that can be specialized to cover a wide variety of human activity, it is not directly related to specific examples of such activity. Nonetheless such examples both inform the intended use of the Konsenti™ system, demonstrate its intended breadth, and may be relevant to particular embodiments.

U.S. Pat. No. 6,765,594 to Hautt et al. is a computer system for managing a fund-raising campaign. One of the objects of the present invention is to support fund-raising, or more generally resource-raising. The Hautt patent is tangentially similar to Konsenti™ in that it discloses targets to be met, and seeks to provide informative reporting to those running a campaign of campaign status as a means to guide the future and current fund-raising effort. The Konsenti™ system implements one specific waydob™ that has the same goal (see the section called “The General Investment Round as an Example”), but with a critical difference: Konsenti™ seeks to build momentum by showing the resources raised (and thus the goodwill and potential success of a proposal) to the participants contributing the money (as opposed to the people who initiate the campaign. More generally, the Konsenti™ system can be thought to build consensus behind any proposal by exposing to potential participants the current level of expressed conditional commitment for that proposal. The Konsenti™ system does not attempt to do what the Hautt patent intends: to manage a widely-distributed fund-raising campaign.

Entire patent classes exist for auctions, but see for example: U.S. Pat. No. 5,835,896 to Fisher and Kaplan, or more recently U.S. Pat. No. 7,089,204 to Nieboer et al. Auctions are a good example of the intended purpose of the present invention, because they represent a large number of people reaching a consensus (specifically, who gets the goods at what price) via a computer network, in which each person potentially makes very simple formal decisions: to raise a bid by a certain amount or not. However, auctions are a single example of the use of the present invention, which is much broader than auctions alone.

There is plethora of prior art relating to voting, see for example U.S. Pat. No. 6,311,190, and more generally class US CL 705/12. Voting, polling, and surveys as a group are similar to auctions in that they represent another example of multi-party consensus (which out of a group of choices wins an election), although one in which the formal decision made by the participants is even simpler than that made by auctions.

MySignUp.com (http://www.mysignup.com) is a firm that allows users to create signup sheets via a GUI. The signup sheet is then made available online. Users may view the signup sheet over the Internet and commit, or “sign up” to one or more actions that are needed. This functionality, like an auction, is a specific example of a waydob™ that is easily supported by the present invention. In fact, a similar example is used to explain the lifetime of an offer. The signup-sheet, the auction, the vote, etc. are all specific example that can be implemented with the present invention.

### Implementation-Realted Prior Art

U.S. Pat. No. 6,018,735 to Hunter (CL 707/5) describes the construction of a finite-state machine to match strings in a text. This is a completely different use than the finite-state machines generated by the present invention, in which each transition represents a human communication of an intention, commitment, or desire. Nonetheless, the art of the finite-state machine has been well known for 40 years; see for example, the Wikipedia article on finite-state machines, [http://en.wikipdediat.org/wiki/Finite_state_machine] and more particularly, the venerable textbook: Hopcroft, John; Ullman, Jeffrey (1979). Introduction to Automata Theory, Languages and Computation, 1st ed., Reading Mass: Addison-Wesley. ISBN 0-201-02988-X

The usefulness of finite-state machines is demonstrated by their use in Unified Modeling Langauge (UML) to model a variety software and human activity, as described in the Wikipedia article on Statechart machines [http://en.wikipedia.org/wiki/Statechart#Harel_statechart].

U.S. Pat. No. 7,174,514 to Subramanian is an example teaching the construction of an interactive web-based experience based on data structures via an implementation and rendering engine. In a different context, the construction of forms to receive input corresponding to legal transitions via a simple interpreter of data structures (not necessarily composed interactively) is a component of the present invention, although such user interface management systems (UIMSs) and form engines have been well-known in the art of software development for decades.

### Objects and Advantages

The purpose of this invention is to facilitate the formation of consensus. By use of the word consensus, it is intended that every participant appreciates that a formal, well-understood mechanism for reaching an agreement has been used, rather than an intention that every participant is happy with the outcome of the consensus.

An advantage of this invention is that it flexibly allows the configuration of new ways of forming consensus, or ways of doing business. An additional advantage is the clarity and the simplicity provided to the participants, since they are interacting with a small set of discrete choices. The fact that the current state of the desires and intentions of other people can be displayed at any point in time is a major advantage of this invention, because it allows other participants to make decisions based on that knowledge. A final advantage is that transitions can be often be canceled simply and clearly. The cancellation of a transition models the common occurrence of someone changing their mind or being unable to fulfill their obligation, while leaving the consensus in a consistent and understandable state.

### BRIEF DESCRIPTION OF THE DRAWINGS

FIG. 1 is a block diagram showing the basic elements that are available to define and implement any type of waydob™.

FIG. 2 is a diagram of a finite-state machine, showing states and transitions for a particular example of a waydob™ called the Judged Piece of Work.

FIG. 3 is a diagram of a finite-state machine for two different example waydobs™, Project with Several Bins and General Investment Round, which can similarly be constructed with choices for elements in FIG. 1.

FIG. 4 is a simple block diagram showing the various pieces of text and graphical information that must be computed before they can be graphically composed in order to present an interaction screen to a potential offer user.

FIG. 5 is a flowchart for the processing of a human-specified transition on a particular offer.

FIG. 6 is a UML diagram of the Offer class.

FIG. 7 is a UML diagram of the EdgeDescriptor class.

FIG. 8 is a UML diagram of the Trans-inst class.

FIG. 9 is a screenshot of offer creation.

FIG. 10 is a screenshot of a offer interaction.

FIG. 11 is a screenshot of a tree of counter-offers.

FIG. 12 is a basic diagram of a computer.

FIG. 13 is a basic diagram of a networked computer.

### SUMMARY OF THE INVENTION

By constructing configurable finite-state machines and specifying simple functions, very diverse forms of human interaction can be modeled. From such a finite-state machine, a proposal can be constructed. Using a simple form-presentation engine, an object-persistence mechanism, and a computer network such as the Internet, many people can view the proposal. They can see the present state of other people's commitments and desires, as expressed through simple interactions with the proposal, but informatively summarized by functions specified when the finite-state machine was created.

A major feature of this invention is to allow people to express a conditional commitment. That is, to assert that they will do something, but only if many other people also agree. Eventually, the proposal may have so much conditional commitment that everyone is fully committed.

By organizing all official interaction as transitions, it is often possible to cancel a transition in a clean way.

### Detailed Description of the Presently Preferred Embodiments

### Assumptions About Our Computational Environment

The Konsenti™ website, which is one of the preferred embodiments of the present invention, is implemented via the free open-source LISP object-oriented database Elephant [http://common-lisp.net/project/elephant]. Furthermore, it uses the Data Collection Management (DCM) contribution in the contrib/rread/dcm directory of that software distribution. The DCM system, utilizing Elephant, provides persistent LISP objects and a timestamp on each managed object in the DCM system. Since these services are provided for free via a publicly and relatively widely-used software package, we take as granted the art of storing business objects with creation timestamps, without discussion of how these objects are mapped into the underlying data stores. These are easily understood by an individual skilled in the art of software development in light of the well-documented Elephant system.

The Konsenti™ system similarly relies on use of a proprietary form engine. This engine can take a declarative descriptions of the names, types, and labels of input fields that are presented to the user and for which responses should be collected. The general features of such a system are well below the novelty requirement of patentability, and should be well-understood by one versed in the art of computer science, although we do not attempt to document the LISP API to this form engine in this specification. Much of the art of such systems is published under the name “User-Interface Management Systems” (see for example: “A light-weight UIMS” Robert L. Read and Martin L. Smith, Software - - - Practice & Experience, Vol. 21, Issue 1, (January 1991). A modern, open-source, LISP package with similar functionality is Marco Baringer's UnCommon Web (UCW) (http://common-lisp.net/project/ucw/).

The basic purpose of this form engine is to take a declarative LISP expression like:

```
‘(stylization
  (“ct” (group (“commitment” (positive))
  (“threshold” (nonnegative))))
  ((“start.start.ct.commitment”
    (before “Enter the amount to which you are willing to commit”))
  (“start.start.ct.threshold”
    (before “Enter the threshold that must be \
raised to trigger your commitment”))))
```

and render it, for example, as a combination of HTML, CSS, and JavaScript that will present a small form to the user asking for a positive number and a non-negative number, the first named the “commitment” and the second named the “threshold”, with the specified labels for the users. After the user enters the required inputs, they can be retrieved from the next HTTP request via the names “commitment” and “threshold”.

We also make use of a freely-available system for regular expression matching, the CL-PPCRE (Portable Perl-compatible Regular Expressions for Common Lisp) by Edi Weitz (http://weitz.de/cl-ppcre/), and in the code samples in the appendices we use a memo-function “memoize-scanner” as a convenience interface to the CL-PPCRE. One skilled in the art of regular expressions will intuitively understand this usage without a full description of the API.

### Waydobs™

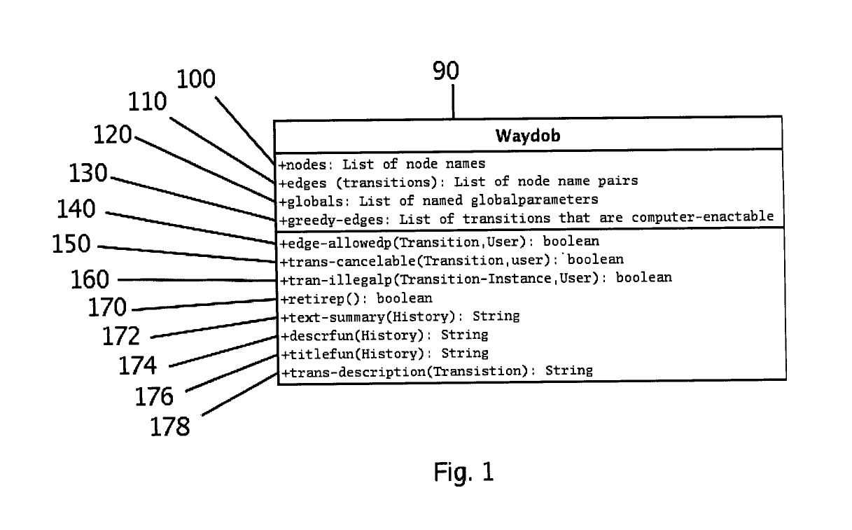

The fundamental structure of this invention is the waydob™ (an acronym for Way of Doing Business) as shown in FIG. 1. The waydob™ is a “class”, although one whose attributes are complex and contain functions, as supported by computer languages such as Java, Python, and especially Common LISP, which is the actual language used to implement the website http://konsenti.com. By assigning all the attributes of a waydob™, one generates an offer template that can be used to create actual offers, which are proposals that can be published to other people.

The waydob™ 90 itself is a class, but it must be understood that instantiating a waydob™ creates a dynamic object that may be persisted and then used to instantiate other objects. This process is all done at run-time, which is different from the behavior of statically-typed languages like Java, where creating a new type, or class of objects, typically requires recompilation. It is thus possible to construct new waydobs™ dynamically based on user input, specifically through a combination of GUI and textual input. As an example, there are now over a dozen waydobs™ usable at the Konsenti™ website, as follows:

†Judged Piece of Work,

†General Investment Round,

†Project with Several Bins,

Simple Vote,

Simple Auction,

Simple Take-it-or-Leave-it,

Finite Offer with Counteroffer,

Investment Club,

General Slotted Project,

Men and Women in Pairs,

Lunch,

RSVP, and

Motion.

Catering.

These titles are indicative of the purpose of each of these waydobs™, but are not intended to fully explain a respective waydob™. All of the thirteen mentioned, and any number of potential waydobs™, are instances of the single waydob™ class, and new such ways-of-doing-business can be created dynamically by specifying new choices for attributes and operators of the waydob™ class. Three specific waydobs™, indicated in this text marked with a dagger (†), are examined in detail as a means to demonstrate the different features available (see the following sections for more information: the section called “The Judged Piece of Work as an Example”, the section called “The General Investment Round as an Example”, and the section called “Project with Several Bins as a Life-Cycle Example”). In addition, the code to implement these examples is included in separate Appendices (specifically, see Appendix A, LISP Code for Judged Piece of Work, Appendix B, LISP Code for General Investment Round and Appendix C, LISP Code for Project with Several Bins).

Many programmers do not generally think of specifying new operators (that is, functions) dynamically, but programming languages that treat functions as first-class citizens make this relatively easy. In particular, when using LISP it is completely natural to specify a function just as dynamically as specifying a string.

### The Judged Piece of Work as an Example

Consider a way of doing business in which someone proposes to pay a certain amount for a piece of work; for example, the translation of a short technical document into another language. One can imagine a marketplace in which the normal way of doing business is to wait until the translation has been returned, and then transfer the translation to a third-party who is responsible for judging the quality of the translation. The judge decides what portion of the originally offered reward should be given to the translator based on the quality of the work. One of the objects of the present invention is to allow such a mechanism for organizing human cooperation by utilizing a networked computer system to originate and manage the transaction.

The attributes of the waydob™ can be generally organized into three groups: those specifying the conceptual structure of the waydob™ (attributes 100, 110, 120, and 130), those specifying functions that control its actual behavior (operators 140, 150, 160, and 170), and descriptive attributes (172, 174, 176, 178) that present to the user information to help them understand the actual purpose of the waydobs™.

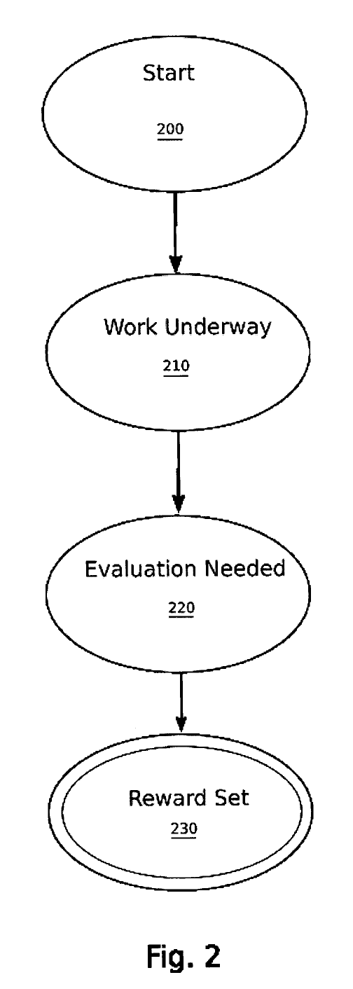

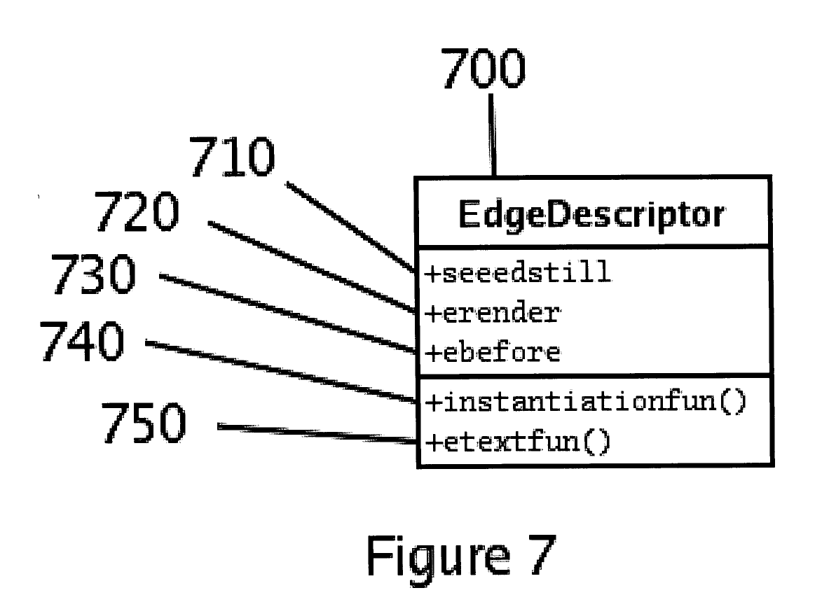

The nodes attribute 100 is simply a list of names representing the conceptual states (to a human understanding) of an offer. For example, in FIG. 2, representing the finite-state machine that implements the Judged Piece of Work waydob™, (see Appendix A, LISP Code for Judged Piece of Work) the conceptual states are Start 200, Work Underway 210, Evaluation Needed 220, and Reward Set 230. A list of edges mapped to objects of the class EdgeDescriptor (see FIG. 7) such as: ((Start,Work Underway), (Work Underway,Evaluation Needed), (Evaluation Needed, Reward Set)) could be specified as the transitions attribute 110 of this waydob™. Taken together the nodes and edges define a statechart, (as shown in FIG. 2) that model the conceptual flow of this waydob™. When the proposer initiates the work and the maximum reward, the offer is created in the Start state. When a user agrees to begin a translation, the offer moves into the Work Underway state. When the translation is done, the offer moves into the Evaluation Needed state. When a third-party judge has evaluated the translation, the offer moves into the Reward Set state, which, because no edges leave it, is a final state.

As it happens, this waydob™ requires one parameter in the globals (that is, parameter associated with the whole offer and accessible by the functions associated with the offer and with the various edges). In this case, the parameter is the maximum reward, which might be expressed as a small number of dollars (but could be an abstract, non-monetary reward). The global parameter has a name, in this case potentialreward, making it accessible to various functions.

The descriptive functions 172, 174, 176, and 178 are without loss of generality functions of the entire History of the offer. The History (see the section called “Cancellation of Transitions”) is a list of all of the parameters specified at each edge transition. The History is an append-only object. New transitions can be added to the list but old ones are never removed or changed. If it is not necessary to compute anything from the History, then of course the descriptive functions can simply return a constant string. For example, a third-party judge would be able to review the translation, the original document, and maximum reward, in order to decide on the actual reward. However, in a secret vote, for example, one would not reveal the current state of the vote to the voters until the vote is finished; therefore the description of a transition would not vary over time.

The function edge-allowedp 140 is used to decide whether a given user is allowed to make a transition. For example, in the case of the Judged Piece of Work waydob™, the user who has made the Work Underway→Evaluation Needed transition (that is, the translator), is not allowed to see or execute the transition that moves the offer from the Evaluation Needed to the Reward Set state. This is because, by the convention of this way of doing business, a person is not allowed to evaluate their own work. The function edge-allowedp is used to compute possible transitions before any information is provided by a user about the transition.

The function tran-illegalp 160 is used to tell if a transition is legal once all of the parameters of the transition has been specified by a person and sent back to the server as an attempted transition. In ideal situations, illegal values will simply not be allowed to be entered by the transition rendering engine. However, there are some circumstances when this legality is too complicated to be computed just as a function of the types of the parameters of the transition. Note that this complexity is independent of whether the computation is performed on the client (the browser, for example) or the server. In the case of the Judged Piece of Work, the Trans-illegal function might check that the specified reward is at most the maximum reward, and would return “true” (meaning illegal) if the reward was too high. (Technically, the Konsenti™ form-rendering system is actually powerful enough to express this in the JavaScript type-checking system, but not all form-processing systems support such things.)

The function trans-cancelable 150 is explained in the subsection on offer histories the section called “Cancellation of Transitions”.

The attribute greedy-edges 130 is used to specify edge transitions that should automatically be taken if they are legal. For example, a greedy- edges is used in the slotted project to close the project when all of the slots are filled.

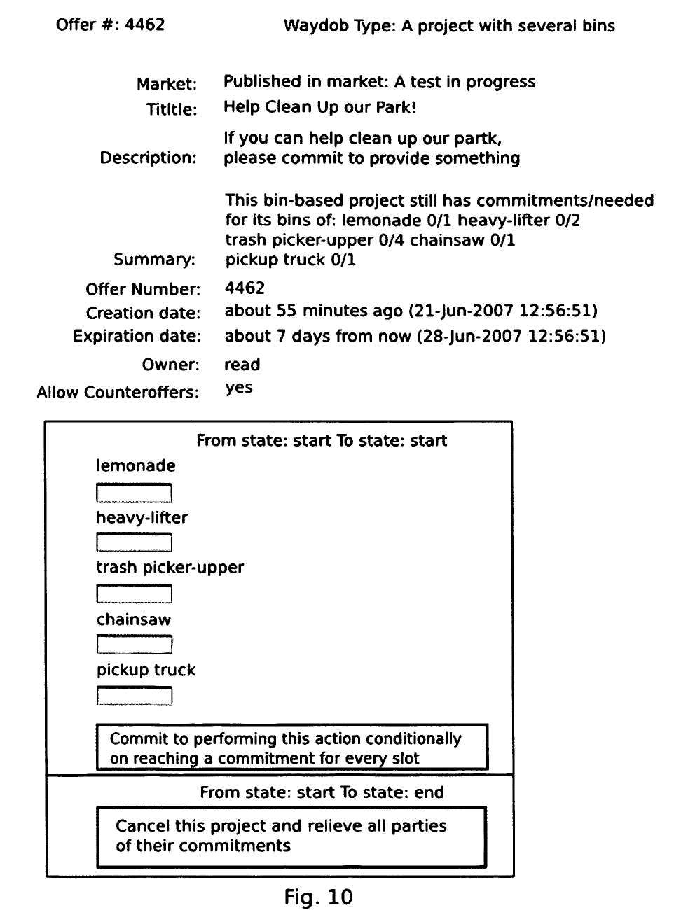

The EdgeDescriptors 700 (see FIG. 7) provide important flexibility. In particular, the seedstill attribute 710 and the instantiationfun 740 cooperate to specify the names, types, and labeling for input elements that must be specified whenever an edge transition for the edge with which they are associated is executed. The seedstill 710 specifies the name, type, and labeling of the inputs required to define the associated transition, while the instantiationfun 740 takes those inputs once the user has defined them and converts them into whatever inputs are needed when the edge transition occurs. In effect, the seedstill and the instantiationfun are used at offer creation time (for more information, refer to the section called “Offer-Creation Time”) to gather whatever information is needed to “compile” the inputs that will later be used at transition time. Important examples of this are the Project with Several Bins and General Slotted Project waydobs™, in which a user enters up to ten “slot names” at the time of offer creation. Later, once the offer has been created and published to at least one user, the slot names are presented as a unified set of check-boxes. For example, the offer creator may specify five slots out of ten at offer creation time, but then at edge transition time, the user is presented with a graphical user interface (GUI) that displays only the five check-boxes that are relevant (as demonstrated in FIG. 10).

The etextufn 750 is used to provide an identifying label for the transition. If specified, the erender function 720 takes the culture and offer and produces a complete HTML rendering of the transition GUI. Specifying the erender function 720 is considered a complete override of the normal form processing, and allows an arbitrary GUI. In particular it allows specifying a GUI that a form-processing engine might not be able to produce. For example, of our current waydobs™, we only use this for the Catering waydob™ which uses a highly customized menu. The function ebefore 730 is a “hook”; it is an arbitrary function on the object and the transaction instance. This function is useful for debugging and to produce other side-effects. For example, in a trading game implemented as a test of our system, it is used to debit and credit accounts before the transaction instance is recorded. In general it is preferable to have completely side-effect free processing, and to base everything on the recording history, but in some cases the hook is needed.

### Offers

I use the term “offer” in a very general sense. An offer is an invitation or a proposal to interact in some way. However, what one is being invited to or what the nature of the proposal is depends completely on the way of doing business in question. Some ways of doing business will fit the term “offer” quite well. For example, one can say, “I am offering this for sale” via a particular waydob™. Other waydobs™, such as those concerning voting, would not normally be described with the term “offer”. However, since this invention concerns the use of proposals based on diverse ways of doing business, and one term of art is required, offer was chosen though it should again be stated that this term should not be considered a limitation of the kind of ways of doing business that can be created.

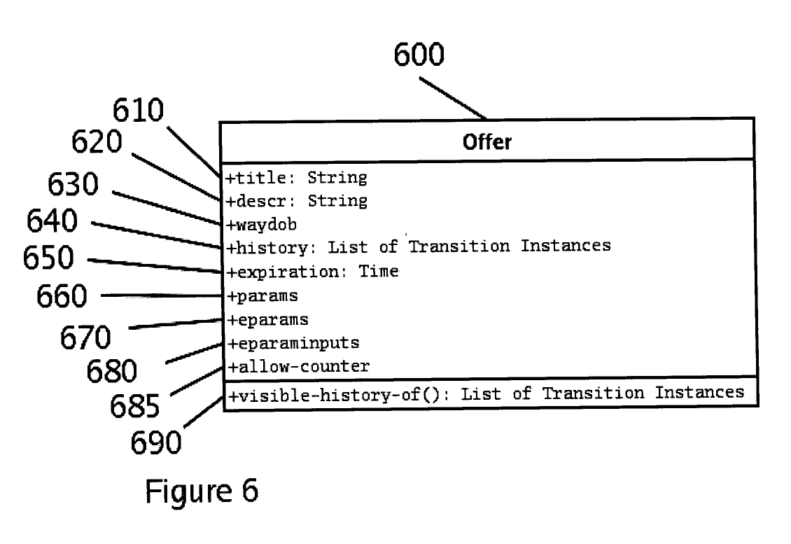

FIG. 6 is a UML class diagram of an offer. Note this is a single class, but instances of it specify a waydob™ via the attribute waydob 630. The history of the object is stored in a list of transition instances 640. Note that the title 610 and description 620 are not functions as they are on the waydob 90, but simple strings. These strings are utilized by the functions on waydob™ object 172 and 174. This allows strings that include the nominal title of the offer and information about the current offer state to be constructed, such as “Lunch at Guido's: 7 participants”, where the nominal title is “Lunch at Guido's” and the rest of the string is computed from the actual offer history. An additional advantage of this is that users expect and demand that is easier to create an offer than to create an entirely new waydob™. Some people may be willing to take the time to understand how to specify a title-function when creating a new waydob™ for inviting people to lunch, but nobody wants to do that when they are just creating a lunch invitation.

Note also that offers have an expiration date/time 650, but waydobs™ do not. Although some proposals may remain open for years, in general they potentially expire. Waydobs™ on the other hand never expire.

The Params 660 attribute is computed at the time the offer is instantiated from the global-parameters 120 of the waydob™ from which the offer is instantiated. This gives us a place to store the actual values of the types (and names) specified by the globals 120 list of the waydob™. The eparams 670 is a map from edges (that is, pairs of nodenames) into name and type parameter lists. The eparams are generated at the offer-creation time. This map is used at the time that a transition is rendered, to get the parameters that must be input to instantiate that transition. eparam-inputs 680 is used to store the raw input of the transition (at offer instantiation time, not transition time), which is useful as a historical record.

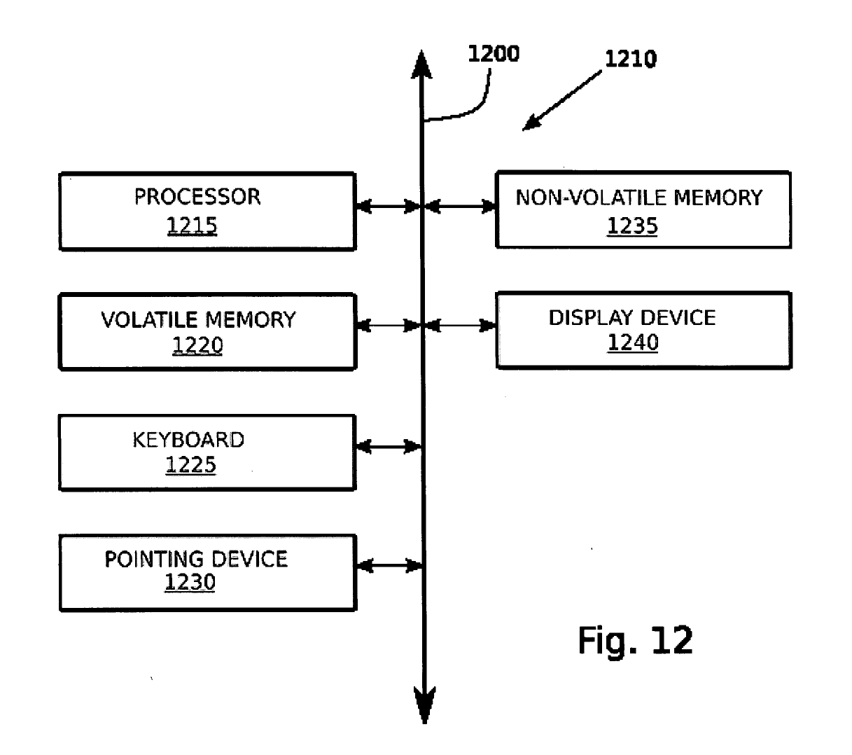

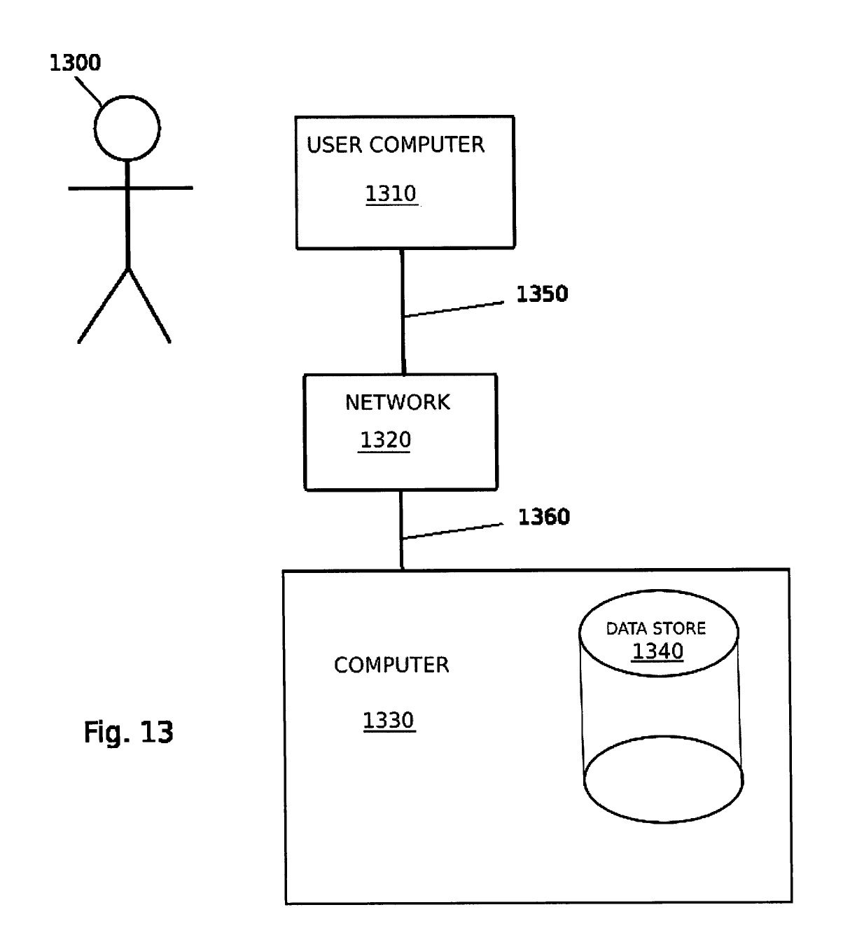

Though to many practitioners it will seem redundant, we now review the basic computer architecture which is used to construct, store, and implement the waydob™. Referring to FIG. 12, a block diagram is shown illustrating a computer system 1210 suitable for server 1330 (discussed in greater detail below), or user system 1310 of FIG. 13, according to an embodiment of the present invention. In various embodiments, system 1210 takes a variety of forms, including a personal computer system, mainframe computer system, workstation, server, Internet appliance, PDA, an embedded processor with memory, etc. That is, it should be understood that the term “computer system” is intended to encompass any device having a processor that executes instructions from a memory medium. Likewise, although the term “server” is used herein above and server 1210 is shown in FIG. 12, it should be understood that the computer system hosting the consensus-building site may take a variety of forms in different embodiments of the invention and is not necessarily limited to a so-called “server.”

The system 1210 includes at least one processor 1215, a volatile memory 1220, (e.g., RAM), a keyboard 1225, a pointing device 1230, (e.g., a mouse), a non-volatile memory 1235, (e.g., ROM), hard disk, floppy disk, CD-ROM, and DVD, and a display device 1240 having a display screen. Memory 1235 and 1220 are used to store program instructions (also known as a “software program”), which are executable by processor or processors 1215, to implement various embodiments of a method in accordance with the present invention. In various embodiments the one or more software programs are implemented in various ways, including procedure-based techniques, component-based techniques, and/or object-oriented techniques, among others. Specific examples include XML, C, C++ objects, Java and commercial class libraries. Components included in system 1210 are interconnected by bus 1200. A communications device (not shown) may also be connected to bus 1200 to enable information exchange between system 1210 and other devices.

The LISP system runs on a computer 1210 in FIG. 12 and 1330 in FIG. 13, and the aforementioned persistent object stores persists the waydobs™ to the datastore 1235 in FIG. 12, and 1340 in FIG. 13. FIG. 13 is described in greater detail in the the section called “Offer-Creation Time”.

### The General Investment Round as an Example

In order to illustrate a non-trivial use of a waydob™, this section intends to describe a waydob™ called General Investment Round, currently implemented at the Konsenti™ website. Note that this is an example, not a preferred embodiment of the current invention, since the current invention is a system for creating and implementing waydobs™ and offers, not a specific set of waydobs™.

Conceptually, a General Investment Round waydob™ is related to the idea of a “matching grant” often used in fund-raising. The idea is that a person may agree to a statement like: “I will give $5,000 to your cause, but only if you raise an additional $10,000 from some other sources.” In the case of a company, this money may be an investment, and the investor may not be willing to shoulder the entire investment needed to execute the business plan. If this is an attempt to raise money for a charity, such a statement may be made in order to encourage others, and the grantee, to reach an ultimate goal of $15,000 (for example, offers of matching grants made on public radio pledge drives and telethons).

General Investment Round goes one step further, and actually does something that would be rather hard to do without a computer. It allows any number of people to make statements of the form “I agree to give X dollars, but only if you raise enough commitments to have at least Y dollars in total sum”, and to express a maximum, which could be considered the fund-raising goal. General Investment Round is a waydob™ from which one can generate an offer, that can then be published in a market to a large number of people. However, based on a small but non-trivial computation and the greedy-edges attribute 130 for the waydob™, the investment round furthermore can take a large mass of statements, entered by a large number of participants who are not in direct communications with one another, and compute when the commitment is viable and regarding whom. A consideration of the following three statements may clarify that it is not completely trivial to compute whether or not an individual is committed.

Alice agrees to pay $2000, but only if $5000 is reached.

Bob agrees to pay $1000, but only if $3000 is reached.

Charles agrees to pay $1000 unconditionally.

If we assume that the overall fundraising goal is $5000, it takes a moment's thought to see that only Charles is committed on the basis of this group of the three conditional pledges.

If an additional conditional commitment is made, as follows:

Alice agrees to pay $2000, but only if $5000 is reached.

Bob agrees to pay $1000, but only if $3000 is reached.

Charles agrees to pay $1000 unconditionally.

Dorothy agrees to pay $1000, but only if $2000 is reached.

Then it becomes obvious that the the commitment becomes viable only when all four donors are committed to pay what they have offered. Another way to think about this is that Charles activates Dorothy's commitment, which activates Bob's commitment, which activates Alice's commitment. Since the goal is $5,000, then the goal has been reached, and the offer can enter a closed, and in this case, committed state, via a Greedy Edge that computes this commitment. A Greedy Edge is a transition that occurs whenever it is legal, without requiring a human interaction. The implementation of Greedy Edges is explained in detail in the section called “Offer-Interaction Time”.

Mathematically we can express this as the function maximal-commitment (5010 in Appendix B, LISP Code for General Investment Round which takes the visible history of the offer as its argument. The visible history contains a list of statements representing the above informal commitment statements. The function maximal-commitment computes the amount that is currently committed. The result is $1000 given the first three statements; and $5000 given the second group of four statements.

However, one of the main objects of this invention is to build consensus by presenting a simple GUI exposing existing agreement. In the case of the General Investment Round, it is useful to display this in the text summary 172 and the description 174, and so when the General Investment Round waydob™ is constructed functions are specified for those two operations, invoking the maximal-commitment function and placing the result in a description and summary that will be read by potential donors. A potential donor is therefore presented with a simple form that provides a text description that partially describes the current progress toward achieving the goal, and includes two inputs: one in which a potential donation can be typed and a threshold with which to activate the donation. In general it is an object of this invention to allow complex interaction between many persons, each of whom is presented with simple decisions.

So in order to specify the General Investment Round waydob™, one must complete the following:

5010 Write a function maximal-commitment,

5020 Specify the start, committed and end nodes

5030 Specify the edge (start,end) and a text label for it,

5040 Specify the edge (start,start) and a text label for it, and the two numbers that a user must input to make a matching grant and their labels,

5050 Specify the edge (start,committed) and list it as a greedy-edge,

5060 Define a function investment-round-text-summary that invokes maximal-commitment and places the result into a descriptive text string,

5070 Define a function investment-round-ti-summary that computes a transition description,

5080 Specify a small form for entering the commitmentgoal with a label at offer creation time,

5090 Write a function that looks up the commitmentgoal global and uses it to define transition to the state committed to be legal if an only if the maximal-commitment is at least the commitmentgoal.

Please associate the numbered bullets with the similarly numbered bullets in Appendix B, LISP Code for General Investment Round, where the entire upper-most level code to create General Investment Round waydob™ is presented. Though this and all referenced code snippets utilize functions and macros that are not defined within the respective snippet, the skilled LISP programmer should be able to understand it, and any skilled programmer familiar with LISP syntax will be able to see how the above specifications can be made in just a few pages of code.

The fact that a waydob™ can be implemented by specifying a relatively small amount of programming code is a significant advantage of this invention. Although we normally think of such things being specified by skilled programmers, the simplicity of the waydob™ class and the fact that it is broken into a large number of simple slots means than non-programmers can potentially specify all of these individual slots by simply typing in very small code snippets. Since LISP is completely dynamic, this is can be done with no additional work in LISP. In Java or C++ this would require a separate compilation and dynamic linking, but is still possible. One could specify all of these functions using a GUI. Many useful functions could be chosen from a menu of pre-defined functions. There is therefore a spectrum of the power of waydob™ creation. At one end, a user who knows nothing about programming can create a new waydob™ by only specifying words that represent conceptual meanings. At the extreme end is the skilled LISP programmer that can create new functions for whatever purpose is required. In the middle is a user who knows how to select functions and perhaps make small modifications from published examples.

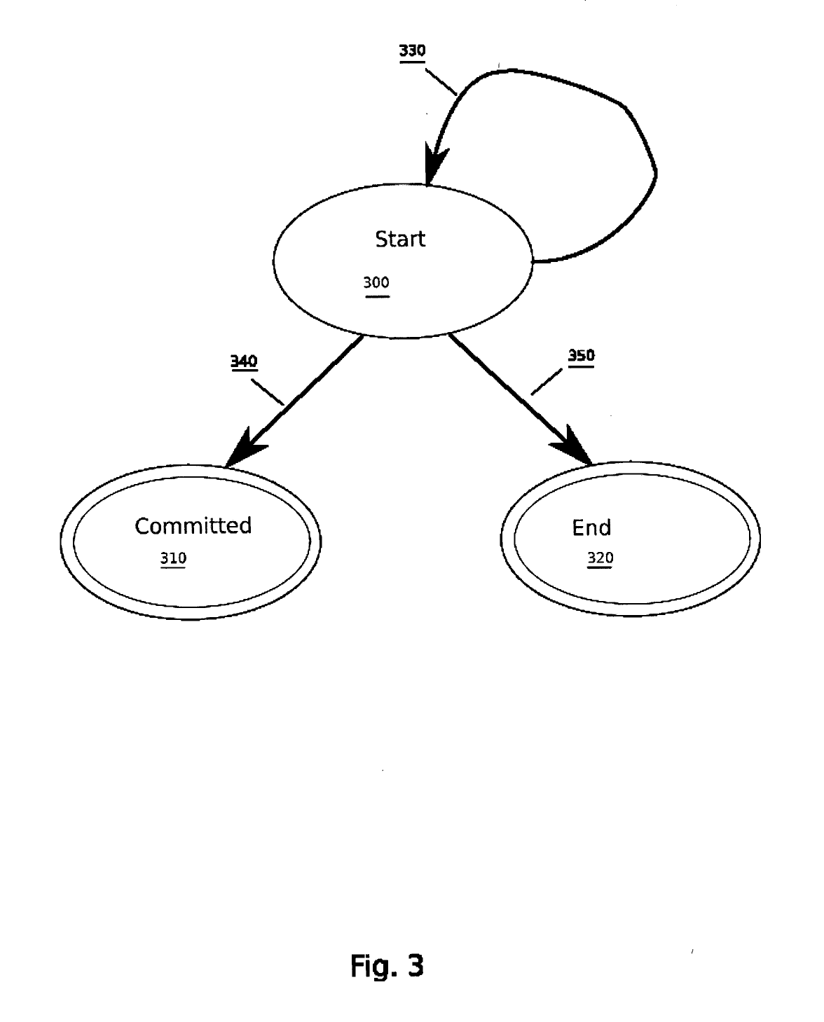

FIG. 3 is a diagram of the conceptual finite-state machine for the General Investment Round created by the actions of this code. (It is interesting to note that exactly the same states and edges are created by the next example, using the waydob™ Project with Several Bins, though the functions needed to define the two waydobs™ that are not shown on this diagram differ.) The start state 300 is the initial state. All transitions that represent resources being collected are loops from the start state into the start state, via the transition or edge 330. There is an edge 340 that is specified as a greedyedge going from state start to state committed 310, when the commitmentgoal is reached. The condition of the commitmentgoal being reached is simply encoded into the edge-allowedp 140 function for this edge. If a greedy edge is allowed, it is taken. There is an edge 350 that is exclusively presented to the owner of the offer, going from state start to state end 320, if the offer creator chooses to terminate the proposal and relieve all participants of their potential commitment. Both the end and committed states are terminal states, since no transition leads out of them. Once they are reached, no further official transitions are allowed. The committed state represents the success of the pledge drive or resource-raising round; the state end represents the failure to obtain the declared required resources.

### The Life-Cycle of an Offer

This section describes the life-cycle of an offer using the Project with Several Bins waydob™ as an example (this is a waydob™ that has not yet been discussed). In general, the basic parts of an offer life-cycle include:

Offer-creation time,

Offer-publication time,

Offer-interaction time,

Offer-expiration time, and/or

Offer-termination time.

Since the object of this invention is to support the construction of human consensus via offers based on waydobs™ expressed as finite-state machines, each phase of this life-cycle requires some explanation.

Creating a waydob™ is analogous to the definition of a finite-state machine. Creating an offer is the act of instantiating a finite-state machine from the definition of the finite-state machine.

Project with Several Bins as a Life-Cycle Example

### Offer-Creation Time

The waydob™ named Project with Several Bins is a very powerful way of doing business used to build consensus around a project that requires a certain number of resources of several different types.

For example, suppose that someone wants to gather volunteers to clean up a park. They may think to themselves, “I don't want to spend my Saturday on this unless we can really make a difference. To do that we need one (1) person with a pickup truck to haul away all the old tires and heavy junk, one (1) person with a chainsaw to trim the trees and cut up the fallen timber, four (4) persons to pick up the light trash, two (2) burly persons to do the heavy lifting, and one (1) person to provide lemonade. I want to get all of these people and resources lined up, so that nobody wastes their Saturday without being able to finish the job.”

This can be modeled as five resources, or bins, of which differing numbers of resources are required in each bin:

pickup truck (1)

chainsaw (1)

four trash picker-uppers (4)

two heavy-lifters (2)

one lemonade-provider (1)

It isn't necessary to make a clear distinction between a pickup truck, the use of a pickup truck for a certain period of time, or the driver for a pickup truck in counting it as a resource—those distinctions can be explained in comments on the offer, if necessary. The basic model of an offer made from this waydob™ is that when enough numbers of each of these 5 resource types are conditionally committed, the entire offer will move into a committed state, and everyone who was conditionally committed will be fully committed.

This is an example of a major object and advantage of this invention: that by allowing people to express a conditional commitment, people may be more willing to show partial support for an idea. The simple act of performing bookkeeping on the desires and intentions of others may be enough to sufficiently encourage a consensus around the idea of cleaning a park; in many cases this consensus might not ever have been possible without a network-based system of expressing consensus via finite-state machines.

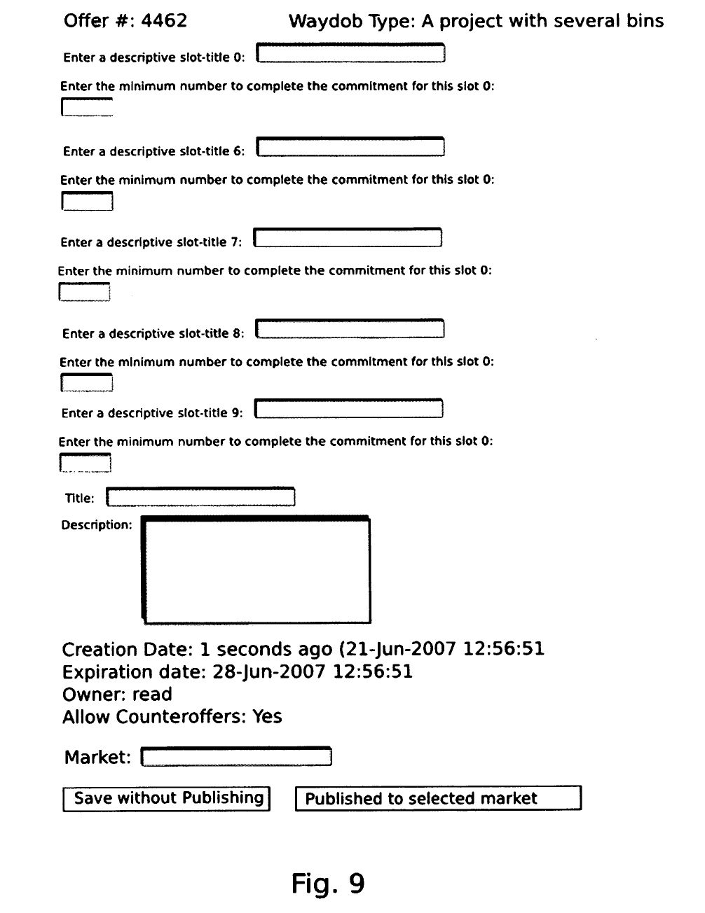

Please see FIG. 9, a screenshot of the actual Konsenti™ interface (with some of the slots removed to scale to fit a single page). This shot shows the places where the “bin” names and the target number of resources needed for each bin can be entered. Additionally note that the title and the description are entered here, which become the strings title 610 and description 620 on the offer.

Although it may seem obvious to one skilled in the art, a review of the aforementioned screenshot, and how it is produced using basic computer architecture, is warranted. The screenshot FIG. 9 is presented to a user 1300 via a computer network system as shown in FIG. 13, or its functional equivalents, that might include PDAs, cell-phones, or other interaction devices. The user 1300 sees a representation of the offer creation forms via a user computer 1310, or some other device that is functionally equivalent even if not called a computer in common parlance, such as a personal MP3 player, PDA or other hand-held device or game console. This computer 1310 has a connection 1350 to a network 1320, such as the Internet or a local area network. The network 1320 has a connection 1360 to a computer 1330 that has a data store 1340, and persists the waydobs™ (and offers and transitions) to this data store. It is by using a network system such as shown in FIG. 13 that a large number of people in different places and at different times can create and/or interact with offers.

Returning to a description of the Project with Several Bins, the greedy edges and computation of how many commitments for each resource exist in the visible history of the offer is similar to that for the investment round. It is algorithmically simpler, but must span several bins.

This example does differ from the General Investment Round waydob™ in an important way. At the time a General Investment Round is created, the user is only required to specify the global value that represents the goal of the General Investment Round. The Project with Several Bins waydob™, on the other hand, requires that a user specify the names of the bins at offer-creation time (five, in the current example) and the number of each needed (1, 1, 4, 2, and 1, in the current example). This is not terribly hard, but it does require the function process-commit-mins-into-fields, which is defined in Appendix C, LISP Code for Project with Several Bins. This function processes 10 pairs of input fields from the user, but creates a bin only if the user enters a title and a number. This of course utilizes the form engine and some regular expression processing as expressed in process-commit-mins-into-field.

Project with Several Bins uses an informative function for computing the text descriptions and summaries, as can be seen in the code listing Appendix C, LISP Code for Project with Several Bins.

### Offer-Publication Time

Because the creation of an offer, such as Project with Several Bins, requires a fair amount of input, for example as many as 10 or 20 pieces of information, the Konsenti™ system separates the publication of an offer to its potential participants from the creation of the offer. Once an offer is fully created, it can still be edited, up until the point where it is published. Once an offer is published, the parameters used for its creation cannot be changed. A major advantage of this approach is to encourage participation by building trust in knowing that the basics of the proposal will not change once someone begins to participate.

The assembly of the offer constructs a waydob™ that is diagrammatically the same as the General Investment Round waydob™ and as depicted in FIG. 3, though the differing specification of the attributes give it different behavior.

### Offer-Interaction Time

Offer interaction time includes the viewing of, commenting on, and executing transitions of an offer. All of these interactions represent something added or appended to the offer. No information is ever removed from an offer or changed on an offer. Although transitions can be canceled, this must be seen as appending a cancellation record to the offer.

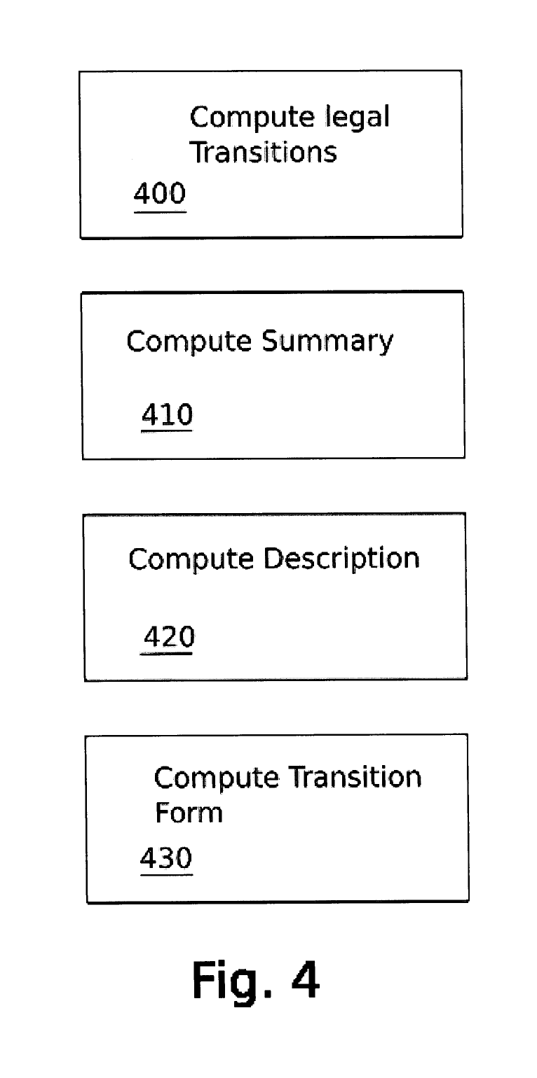

Once an offer is published in the Konsenti™ system, a user may learn of it either through an invitation email or in a list of offers in a market. (The invitation system is beyond the scope of this invention.) If a user sees a link to an offer and browses to it, the basic offer rendering process is shown in FIG. 4. Note that FIG. 4 is expressed as a simple block diagram rather than as a flow chart because the order of these operations does not matter. The first step 400 is to compute legal transitions, on the basis of the state of the offer and the identity of the user. As mentioned in the Judged Piece of Work example, the transitions open to a given user do indeed depend on the state of the offer. As we have seen, the computation of the summary 410 and the description 420 is done by simply invoking the specified functions on the waydob™, which are a function of the offer 172 and 174. The title is also computed via 176, and the descriptions for the individual transitions that are legal for this user are computed via the function 178, corresponding to step 430. All of these results are essentially concatenated together into an attractive form that shows all of the relevant information. Each transition receives a portion of the screen space, in general rendering a small form of input that is needed for that transition.

See FIG. 10, which shows the our example offer at offer interaction time. Note the two transitions (the transition to the end is rendered in this case, since the owner of this offer was the user to whom it was rendered) and the fact that the “bins” entered at offer creation time out of the 10 available slots are now conveniently reduced to present exclusively only those options entered on the transition, and that the user is unaware that there might have been fewer or more options at one time. Into an option a user can type a number representing a certain number of resources to commit. Note that the function for producing the text summary 172 has in this case constructed a text summary that shows how many commitments have been made for each bin, and how many are required. In this case it reads: “This bin-based project still has commitments/needed for its bins of lemonade 0/1 heavy-lifter 0/2 trash picker/upper 0/4 chainsaw 0/1 pickup truck 0/1”. The actual code for computing this is bin-project-text-summary, marked by 5100 in Appendix C, LISP Code for Project with Several Bins

FIG. 10 shows a screenshot of a browser at offer interaction time. However, one skilled in the art of computer technology will understand that such a form for interacting with the offer can be presented in a variety of ways. For example, it can be emailed, since modern mail clients render HTML, and it is easy to encode all interactions as URL requests that specify parameters defining the interaction. Moreover, the same information could be presented in a plain-text form. A plain-text interface might be useful for cell phones or PDAs, for example. A more advanced GUI than supported by HTML could also be employed, by using a game engine, a game console, or a 3-D rendering engine. The essential need is to present and collect the parameters and meanings of the transitions.

Note also that each of the 2 allowed transitions is given its own visual area. In this embodiment, the transitions descriptions help the user understand the meaning of the transitions, and are computed by the function Trans-description (see 178) and placed inside the buttons that the user clicks in attempt to execute a transition. In this example, these descriptions, which label the corresponding buttons, are: “Commit to performing this action conditionally on reaching a commitment for every slot”, and “Cancel this project and relieve all parties of their commitments”.

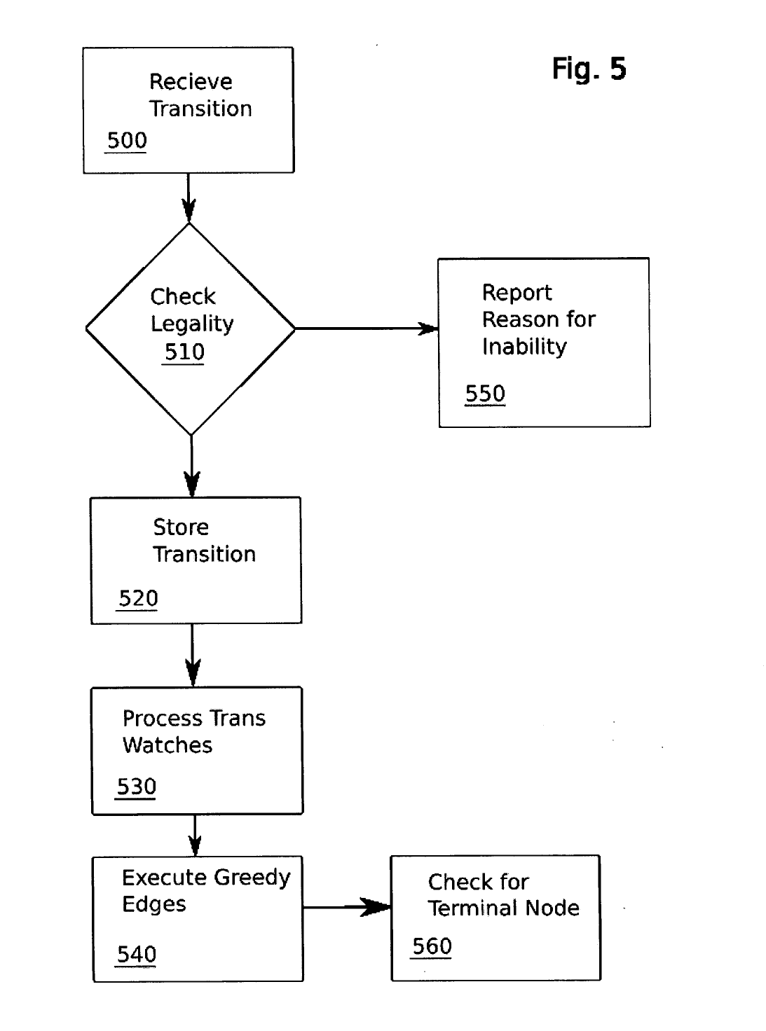

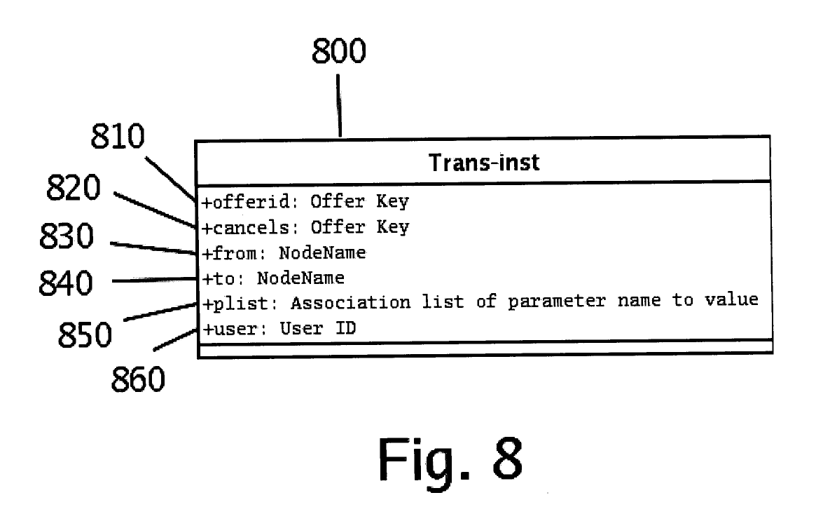

A user may interact with the offer by attempting to execute a transition. FIG. 5 shows what happens after a user fills out a transition form, which may have JavaScript type-checking code, and clicks on the labeled button to execute the transition. In a browser-based embodiment, the user's form input is processed based on the names of the input items. From this a proposed Trans-inst (Transition Instance) 800 (see FIG. 8) is constructed by step 500 in FIG. 5. The input is used to construct the plist or parameter list 850, which associates the names with the input values. The to node 840 and from node 830 obviously depend on which transition the user chose, the user 860 is simply the user id of the user performing the action, and the offer id 810 is the offer with which the interaction occurs. The cancels attribute 820 is null unless this is a cancellation, in which case it will identify the transition that will potentially be canceled, which then causes the plist to be set to null.

A user may comment on an offer or create a counter-offer; however, this comment is outside the purview of state-transition. Although comments are durable and may be necessary to understanding the proposal, they are irrelevant to the official result, just as someone's comment on a vote is irrelevant to the actual vote count.

Once the Trans-inst 800 is constructed, the function Trans-illegal 160 on the waydob™ type of this offer is invoked. This determines whether the transition is legal 510 and, if it is not, presents a meaningful reason back to the user in the form of an HTML response (step 550). It is always better to to prevent the user from inputting illegal data. However, it is not always possible to carry out such a computation on the client side (that is, in JavaScript), so this step is generally necessary and often useful. If the Transition Instance is legal, it is placed (in step 520) directly into the history of the offer. Although one might imagine that there should be some more sophisticated processing, the approach is to make a straight record of the user's input and push the interpretation of this input into the other functions on the waydob™ and the offer. This follows the “DRY” principle of computing, (Don't Repeat Yourself), a corollary of which is: Don't compute and store something that can be efficiently computed on the fly. No offer computation is likely to approach the human time needed to interact with an offer, so elegance of programming is far more important than computational efficiency in this situation.

The storing of the Transition Instance represents an event which may cause email or other notifications to be sent out. The Konsenti™ system implements a method by which “watches” can be set on such events. What the watches actually do is beyond the scope of this invention; nonetheless the “hook” upon which such watches can be activated is mentioned here (530) to demonstrate a conceptual advantage of organizing all offer interactions in the form of state transitions.

A final step is to execute any greedy edges that can legally be executed 540. Examine the list of greedy edges. For any leading out of the current state (which is a function of the history of transitions), check to see if they are legal. This is done by constructing a Trans-Inst 800, necessarily with a null plist, and invoking 160 on it. In practice this is done by recursively invoking the algorithm of FIG. 5, since one greedy edge transition may lead to another. This is the mechanism by with the General Investment Round and Project with Several Bins enter their committed states: a greedy-edge that is legal only when the offer is fully satisfied transitions them to a committed state from which no edges lead out.

### Offer-Termination Time

If an offer enters a terminal node, the offer is retired 560. The act of retiring an offer never deletes it, but removes it from market publication. However, the entire history of the offer remains a permanent and durable record of every interaction with it, for ever and ever. A retired offer can no longer have a state transition.

### Offer-Expiration Time

Some users are privileged to retire an offer at any time. These are normally the administrators of the markets into which it is published and the owner of the offer itself.

Perhaps more commonly, an offer “expires” when its expiration date is met. This triggers the retirement of the offer.

In general, an expiration date 650 is associated with each offer at the time that it is created. The Konsenti™ default is one week in the future, but the default may be overridden. The expiration of the offer may indeed signify that the offer stands only until the expiration date, and that if the offers does not enter a closed state by that time, the participants are relieved of any commitment they have expressed which is conditional on the basis of the offer reaching a closed state (exemplified by the Project with Several Bins).

A necessary part of forming consensus is the realization that there is not always sufficient support to fulfill a proposal. The expiration of an offer before entering a closed state may indicate such a situation. The philosophy is that it is better to learn that there is not enough support for a project than to continue working on a task that will never succeed.

### Custom Renderings

The function erender 720 on an EdgeDescriptor (See FIG. 7) can be used to circumvent the form engine and provide an arbitrary rendering of transition at offer interaction time. This is sometimes necessary. For example, we have a waydob™ that represents catering. Since the menu options are always changing, if they were encoded in the waydob™ itself, the waydob™ would have to constantly change. A better approach is to utilize a function that dynamically reads the menu and computes how to conveniently present the menu and thereafter receive choices from the user.

### Cancellation of Transitions

One of the great advantages of organizing consensus-building as transitions of a finite automaton is that one can often cancel a transition and retain a consistent state. By using a finite automaton, a simple system for recording cancellations to specific transitions can apply to the great majority of waydobs™.

A typical need to cancel a transition occurs when the owner of an offer learns that a commitment which someone has made is either false or invalid due to reasons beyond the control of the committer. For example, imagine an offer to get eight volunteers together for strenuous volunteer work cleaning a park. Someone who committed using their system at work may take ill and without even having access to the Internet may call the offer owner to explain they are too ill to continue. The offer owner could then remove the transition of the ill person, thereby setting the offer to a state almost as if the removed individual had never committed. This allows the organization of the work party to continue, correctly modeling the current state of affairs. A different, but important, case occurs when the offer owner believes that a committer is incompetent, irresponsible, or ill-suited to their commitment. The owner may then wish to cancel that person's transition, even if they are unwilling or unable to remove them from the whole market. As this may hurt the feelings of the person whose transition is canceled, it should not be taken lightly—but the etiquette of such situations is beyond the scope of this invention.

Not every waydob™ can have any transition canceled. For example, some conceptual states depend on previous conditions so strongly that to remove a previous condition invalidates the entire offer. This is the purpose of the Boolean function 150 trans-cancelable which is used to determine whether a given transition is cancelable or not. For example, the waydob™ for the Project with Several Bins which is used to collect resources for a project, is implemented with a function instantiated for trans-cancelable that allows any transition to be canceled. This is based on the notion that no one's commitment strongly depends on the commitment of others (this may not be strictly true, but is the best model of that waydob™). However, the Judged Piece of Work does not allow an early transition to be canceled, because the current state of the offer would not be clear, or would have to be recomputed in a process that would be more difficult than just canceling the offer and creating a new one.

The trans-cancelable function 150 is a function of the offer, the transition, and the user. The default value for this function is simply: is the user who would cancel the transition the offer owner? If so, the transition can be canceled. However, as previously mentioned, for some waydobs™ this function may have to be more sophisticated.

Canceling a transition does NOT remove it. Rather, a permanent record of the cancellation is entered into the append-only, immutable history for this offer. This allows an “audit trail” for the offer that gives transparency and confidence to all participants. One's transition may be canceled, but it will always be clear who did so and when (though not necessarily why). This also allows for the cancellation to be canceled, restoring the original state, which is a very valuable Konsenti™ feature.

A crucial operation for simplifying the specification of the functions needed to implement particular waydobs™ is the computation of visible-history-of 690 an offer. The visible history is the history that contains only non-canceled transitions. The real history, of course, must contain all the transitions and the records of their cancellations in order to maintain the audit trail, and to allow the cancellation of a transition to be undone.

TABLE 1
Offer History

| Id | User | Date | From State | To State | Cancels |
|---|---|---|---|---|---|
| 1 | read | 23-Feb-2007 18:02:26 | Start | Start | null |
| 2 | kavaliro | 27-Feb-2007 12:02:10 | Start | Start | null |
| 3 | johnson | 03-Mar-2007 09:10:34 | Start | Start | null |
| 4 | read | 04-Mar-2007 17:34:01 | | | 3 |
| 5 | kavaliro | 29-Feb-2007 08:13:52 | Start | Start | null |

Table 1, “Offer History” shows a simple offer history, in which 4 state transitions have occurred. The fourth entry in the history is the cancellation of transition #3. The Offer History also records the parameter list for each transition (however, the parameter list changes with each waydob™ and transition type and therefore generally is not easily shown in a table).

Note that in this table transition #4 performed by “read” is a cancellation of transition #3. Thus neither transition #3 or #4 would be part of the “visible history” of the offer.

### Counter-Offers

One can readily imagine constructing a waydob™ in which a transition represents a counter-offer. For example, the Konsenti™ website already has a waydob™ entitled Finite Offer with Counter-offer. However, in general the notion of making a counter-offer is so useful that it is valuable to support this notion directly, and for all existing and future specified waydobs™.

The attribute allowcounter 685 of the offer class, chosen at offer-creation time, is used to control whether the creator of an offer allows counter-offers to be linked to the specified offer.

If so allowed, a user may make a new offer (of the same waydob™ type) that is explicitly linked to an originating offer. The new offer is called “counter-offer” although it may be as simple as proposing a change in the time for a planned lunch. Since a counter-offer is an offer, and offers may have any number of counter-offers, in general there can be a tree of offers related to a single initial proposal. It is an object of this invention to support such trees of slightly varying proposals in order to facilitate people making the best decision. It will be quite gratifying when the Konsenti™ system is used to organize debate and political compromise. For example, a proposed bill and its amendments could be an offer and/or counter-offers, and the offers could measure the political support (in terms of votes or some other metric of support). It is a great hope that political compromise that provides the greatest possible utility to the political body as a whole may be found through this invention, when it may have otherwise been undiscovered or impossible.

In the Konsenti™ user interface, the tree-like structure of the offers and counter-offers can be shown. Although each counter-offer is an independent offer, the entire family of offers associated with an originating offer can be manipulated by the owner in a single action, thus easing the management of offers.

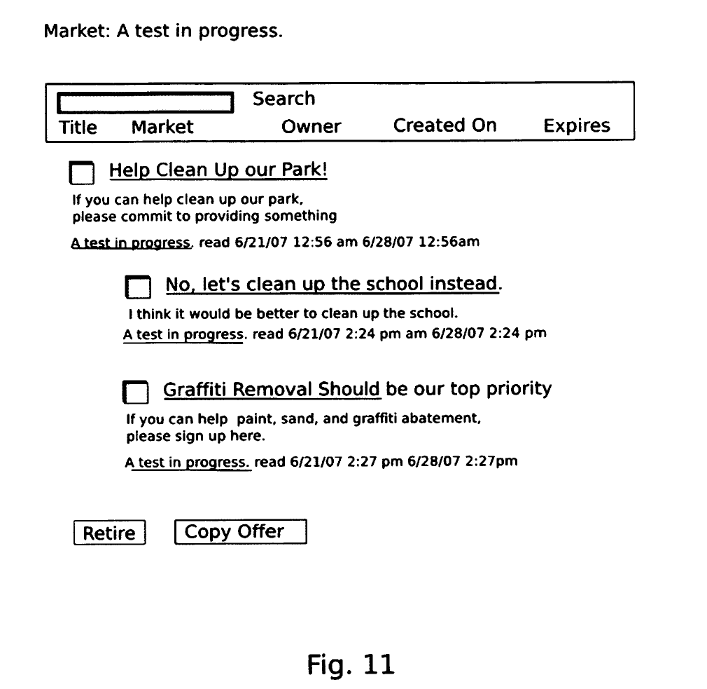

See FIG. 11, which shows a screenshot of the market display of the example offer to clean up a park, which has two counter-offers. As the reader can see, someone has made a suggestion: “No, let's clean up the school instead.”, and someone else has asserted “Graffiti Removal Should be our top priority”. Since these offers are all competing for the energy and interest of presumably a small number of local residents, it is reasonable that they be organized as counter-offers to an initial offer.

Although one can anticipate a system in which one votes on a variety of competing counter-offers, it is not an object of the current invention implemented via the counter-offer feature. If one desires to do that, then one must design a waydob™ specifically for that purpose, and thereby define the rules for what it means to shift allegiance from one choice within the offer and another. Such waydobs™ are within the scope of this invention, though not discussed in detail.

### Clarifications of Other Useful Features

This section briefly describes some important features of the Konsenti™ system specifically designed to enhance the Konsenti™ user experience and that may aid the reader in understanding the utility of the invention.

### Markets

Although it is not a claim of this invention, a brief description of how Konsenti™ uses markets and privilege control may help the reader understand the utility of the present invention.

In the Konsenti™ system, offers are published in markets. A market has an owner. The owner of the market can control who can see, interact with, and create offers in that market. They can make these features accessible to the general public if they wish. The can invite users into a market they own, and can remove users if they choose. A market can be a private affair between just two people, if desired.

Thus the market represents an important mechanism for controlling who can see an offer. In general, an offer is an invitation to participate in something, and in general one is inviting the members of a market to that offer when publishing the market.

However, markets do not provide all of the identity-based control that one needs. For example, in most common usage of the term “vote”, no person is allowed to vote more than once. This is a constraint on who-can-do-what, which cannot be controlled via a market. Therefore offers themselves can have rules (expressed via the functions already introduced, such as 140) that depend on the identity of the person interacting, or potentially interacting, with the offer. The Judged Piece of Work similarly has the rule that the person who performed the work cannot act as the judge (see the function associated with the symbol :tran-illegalp in Appendix A, LISP Code for Judged Piece of Work).

### Comments

As previously mentioned, some of the prior art (U.S. Pat. No. 5,216,603 to Flores) attempts to model a conversation, and allows comments to be a formal part of that model.

There is nothing to prevent the creation of a waydob™ in which a transition is nothing more than the addition of a comment, where the comment is an edge parameter of the type “text” collected at edge transition time. However, we consider comments so important and ubiquitous that we have implemented a software system that allows multiple, dated comments to be attached to offers, offer transitions, and transition instances of offers. The history of all of the comments and who made them is always preserved. In this way, comments are allowed without forcing the person who designs a waydob™ to think about allowing comments into the work flow, unless they are needed for that work flow.

### Conclusions, Ramifications, and Scope

One preferred embodiment has been presented in some detail. One skilled in the art will understand a large number of functionally equivalent embodiments. For example, rather than using a browser, one could use a special-purpose client (a “desktop-app” in common parlance). One will see that functions for producing textual summaries can be expanded to functions providing graphical or symbolic representations. Although our embodiment is in LISP, there is no dependence on this as an implementation platform, and the system could be programmed in any other language. Similarly, we have described an object-oriented approach, but one can imagine associating the appropriate functions with offers and waydobs™ via a different mechanism. The embodiment presented here is very dynamic, but a statically compiled system is equivalent for most purposes.

This specification has presented screenshots of a particular graphical user interface, but one could use a non-graphical interface, or a cell-phone based interface, or a completely different user interface.

This specification has presented three specific examples in some detail (including the code needed to implement them), but these are example instances, since the invention itself is the mechanism by which such example ways of doing business can be configured, and the invention should not be considered limited to these examples, or even the other 10 examples whose titles are given in this specification.

The ramifications of this invention are that human cooperation on any scale can be formed more easily. This may be as simple as two or three people deciding where to go to lunch. It might be as complex as raising millions of dollars for some noble cause. It might be as simple as the pre-sale of some literary or artistic work or ware in order to convince the creator that the risk of producing this object is low. It might be the cooperation of making commercial sales, or the organization of educational and charitable activity.

One of the most important ramifications of this invention is that by allowing ways of doing business that allow the expression of conditional support for an idea, the so-called bandwagon effect can be used to actually create enough support that a proposal reaches fruition.

An essential aspect of this invention is that it enables people to use their creativity in representing existing human ways of forming consensus, and perhaps to create new mechanisms and implement them. For example, the mechanisms known as the “vote” and the “auction” can be implemented with this invention. However, there are probably ways of doing business that are in use that are unknown to the inventor, and therefore cannot be mentioned here. These mechanisms may not yet even have names. The possibility of having a convenient, network-based computer system may spur the imagination of people to create new formal ways of doing business which can be configured and implemented with this invention. We have attempted to demonstrate this with the three examples described in detail herein, which conveniently implement ways of doing business that are well-understood but somewhat uncommon due to the difficulty of performing the needed bookkeeping for them.

It should be pointed out that a group of people will often form the consensus that they in fact don't want to clean up the park or go to a dinner party. It is better to learn this ahead of time, than to throw a party that nobody attends. This invention can help one reach the consensus that a proposal does not have enough support, just as it can help gather support for a proposal.

This invention does not form consensus. It enables bookkeeping of the things needed to form consensus. Accounting of money is a professional activity that is sometimes ridiculed as being boring—but it is essential to the efficient functioning of business, government, and even households. So too is the Konsenti™ system doing something essential—it is tracking and reporting on people's wants, needs, and promises. It is a mechanism for implementing the accounting of people's intentions.

1. A method for forming agreement or consensus among users communicating via a network of computer systems, the method comprising:
A) receiving a specification of a finite-state machine and responsively storing the specification on a first computer system, wherein the specification includes:
i) a set of named states;
ii) a set of transitions between a current state and a target state wherein each of said transitions include a set of transition parameters to be collected when a responding user executes a transition;
iii) a function that produces an informative offer representation from offer finite-state machine attributes, offer finite-state machine state, and offer finite-state machine stored transition executions and parameters instances; and
iv) a function that produces an informative transition representation from offer finite-state machine attributes, offer finite-state machine state, transition target state, and offer finite-state machine stored transition executions and parameter instances;
B) receiving via the network offer instantiating attributes from an offer-initiating user and instantiating on the first computer system an offer finite-state machine from said specification of the finite-state machine;
C) presenting via the network an offer representation computed from the specified offer representation function and presenting transition representations computed from the specified transition representation function of the offer finite-state machine; and
D) receiving via the network responding user transition decisions and transition parameter instances and changing the state of the offer finite-state machine to the transition target state and storing the transition execution and parameter instances responsive to a responding user executing a transition decision;
wherein the transitions may lead responding users and offer-initiating users to form agreement or consensus by transitioning the offer finite-state machine state to a state representing agreement or consensus.

2. The method of claim 1, said receiving a specification of the finite-state machine by the method further including:
a set of global parameters, and
wherein said global parameters are available to functions of the offer finite-state machine.

3. The method of claim 1, said receiving a specification of the finite-state machine by the method further including:
a transition legality function,
and the method further including:
not executing transitions that are not legal as defined by the transition legality function.

4. The method of claim 3, said receiving a specification of the finite-state machine by the method further including:
specifying a set of greedy transitions, and
and the method further including:
executing any legal greedy transition immediately after any transition is executed.

5. The method of claim 1, the method further including:
presenting the history of transitions.

6. The method of claim 5, said receiving a specification of the finite-state machine by the method further including:
specifying a cancelability function that determines the cancelability of canceling a transition execution, and the method further including:
allowing a specific transition execution to be canceled when so permitted by said cancelability function.

7. The method of claim 1, the method further including:
specifying an offer as a counter-offer of some other offer; and
presenting a representation of counter-offer structure.

8. The method of claim 1, said receiving a specification of the finite-state machine by the method further including:
specifying a rendering function that provides a custom rendering of the form used for collecting transition parameter instances,
and the method including:
invoking said rendering function to render said form used for collecting transition parameter instances.

9. The method of claim 1, the method further including:
specifying an expiration date; and
expiring the offer on said expiration date
wherein the expiration of the offer is controlled.

10. The method of claim 5, the method further including:
allowing a plurality of comments to be associated with an offer or a transition; and
rendering those comments to the viewer,
wherein comments can be made on viewed.

11. A computer program product, stored on a computer readable medium, for facilitating the formation of agreement or consensus among a group of participants, the computer program product having instructions for execution by a computer, wherein the instructions, when executed by the computer, cause the computer to implement a method comprising the steps of:
A) receiving a specification of a finite-state machine and responsively storing the specification on a first computer system, wherein the specification includes:
i) a set of named states;
ii) a set of transitions between a current state and a target state wherein each of said transitions include a set of transition parameters to be collected when a responding user executes a transition;
iii) a function that produces an informative offer representation from offer finite-state machine attributes, offer finite-state machine state, and offer finite-state machine stored transition executions and parameters instances; and
iv) a function that produces an informative transition representation from offer finite-state machine attributes, offer finite-state machine state, transition target state, and offer finite-state machine stored transition executions and parameter instances;
B) receiving via the network offer instantiating attributes from an offer-initiating user and instantiating on the first computer system an offer finite-state machine from said specification of the finite-state machine;
C) presenting via the network an offer representation computed from the specified offer representation function and presenting transition representations computed from the specified transition representation function of the offer finite-state machine; and
D) receiving via the network responding user transition decisions and transition parameter instances and changing the state of the offer finite-state machine to the transition target state and storing the transition execution and parameter instances responsive to a responding user executing a transition decision;
wherein the transitions may lead responding users and offer-initiating users to form agreement or consensus by transitioning the offer finite-state machine state to a state representing agreement or consensus.

12. The computer program product of claim 11, said receiving a specification of the finite-state machine by the method further including:
a set of global parameters, and
wherein said global parameters are available to functions of the offer finite-state machine.

13. The computer program product of 11, said receiving a specification of the finite-state machine by the method further including:
a transition legality function,
and the method further including:
not executing transitions that are not legal as defined by the transition legality function.

14. The computer program product of 13, said receiving a specification of the finite-state machine by the method further including:
specifying a set of greedy transitions, and
and the method further including:
executing any legal greedy transition immediately after any transition is executed.

15. The computer program product of 11, the method further including:
presenting the history of transitions.

16. The computer program product of 15, said receiving a specification of the finite-state machine by the method further including:
specifying a cancelability function that determines the cancelability of canceling a transition execution,
and the method further including:
allowing a specific transition execution to be canceled when so permitted by said cancelability function.

17. The computer program product of 11, the method further including:
specifying an offer as a counter-offer of some other offer; and
presenting a representation of counter-offer structure.

18. The computer program product of 11, said receiving a specification of the finite-state machine by the method further including:
specifying a rendering function that provides a custom rendering of the form used for collecting transition parameter instances,
and the method further including:
invoking said rendering function to render said form used for collecting transition parameter instances.

19. The computer program product of 11, the method further including:
specifying an expiration date; and
expiring the offer on said expiration date
wherein the expiration of the offer is controlled.

20. The computer program product of 15, the method further including:
allowing a plurality of comments to be associated with an offer or a transition; and
rendering those comments to the viewer,
wherein comments can be made on viewed.

21. A computer system comprising: a processor; and a storage device connected to the processor, wherein the storage device has stored thereon an agreement and consensus formation facilitation program for controlling the processor, and wherein the processor is operative to execute instructions of the program to implement a method comprising the steps of:
A) receiving a specification of a finite-state machine and responsively storing the specification on a first computer system, wherein the specification includes:
i) a set of named states;
ii) a set of transitions between a current state and a target state wherein each of said transitions include a set of transition parameters to be collected when a responding user executes a transition;
iii) a function that produces an informative offer representation from offer finite-state machine attributes, offer finite-state machine state, and offer finite-state machine stored transition executions and parameters instances; and
iv) a function that produces an informative transition representation from offer finite-state machine attributes, offer finite-state machine state, transition target state, and offer finite-state machine stored transition executions and parameter instances;
B) receiving via the network offer instantiating attributes from an offer-initiating user and instantiating on the first computer system an offer finite-state machine from said specification of the finite-state machine;
C) presenting via the network an offer representation computed from the specified offer representation function and presenting transition representations computed from the specified transition representation function of the offer finite-state machine; and
D) receiving via the network responding user transition decisions and transition parameter instances and changing the state of the offer finite-state machine to the transition target state and storing the transition execution and parameter instances responsive to a responding user executing a transition decision;
wherein the transitions may lead responding users and offer-initiating users to form agreement or consensus by transitioning the offer finite-state machine state to a state representing agreement or consensus.

22. The computer system of claim 21, said receiving a specification of the finite-state machine by the method further including:
a set of global parameters, and
wherein said global parameters are available to functions of the offer finite-state machine.

23. The computer system of 21, said receiving a specification of the finite-state machine by the method further including:
a transition legality function,
and the method further including:
not executing transitions that are not legal as defined by the transition legality function.

24. The computer system of 23, said receiving a specification of the finite-state machine by the method further including:
specifying a set of greedy transitions, and
and the method further including:
executing any legal greedy transition immediately after any transition is executed.

25. The computer system of 21, the method further including: presenting the history of transitions.

26. The computer system of 25, said receiving a specification of the finite-state machine by the method further including:
specifying a cancelability function that determines the cancelability of canceling a transition execution,
and the method further including:
allowing a specific transition execution to be canceled when so permitted by said cancelability function.

27. The computer system of 21, the method further including:
specifying an offer as a counter-offer of some other offer; and
presenting a representation of counter-offer structure.

28. The computer system of 21, said receiving a specification of the finite-state machine by the method further including:
specifying a rendering function that provides a custom rendering of the form used for collecting transition parameter instances,
and the method further including:
invoking said rendering function to render said form used for collecting transition parameter instances.

29. The computer system of 21, the method further including:
specifying an expiration date; and
expiring the offer on said expiration date
wherein the expiration of the offer is controlled.

30. The computer system of 25, the method further including:
allowing a plurality of comments to be associated with an offer or a transition; and
rendering those comments to the viewer,
wherein comments can be made on viewed.
